(19) United States
(12) Patent Application Publication
(10) Pub. No.: US 2026/0254949 A1
(43) Pub. Date: Aug. 27, 2026

(54) INTRA SUB-PARTITION IMPROVEMENTS

(71) Applicant: INTERDIGITAL CE PATENT HOLDINGS, SAS, Paris (FR)

(72) Inventors: Kevin REUZE, Rennes (FR); Karam NASER, Mouazé (FR); Philippe BORDES, Laille (FR); Ya CHEN, Rennes (FR)

(21) Appl. No.: 18/874,631

(22) PCT Filed: Jun. 14, 2023
(86) PCT No.: PCT/EP2023/065974

§ 371 Date: Dec. 13, 2024

(30) Foreign Application Priority Data
Jun. 29, 2022 (EP) 22305946.0

(51) Int. Cl. H04N 19/11; H04N 19/167; H04N 19/176

(52) U.S. Cl. CPC H04N 19/11; H04N 19/167; H04N 19/176

(57) ABSTRACT

Intra sub-block partitioning (ISP) is changed to improve coding in certain instances. In one embodiment, when the ISP direction and Intra Prediction Mode (IPM) are both oriented in one direction, it is proposed to change the splitting for the sub-partitions. Depending on the embodiment, the IPMs considered vertical can be all IPMs with index greater than value (34), or the IPMs considered vertical could be only IPMs with an index value greater than (50) to only account for modes that only use the above reference samples. In another embodiment, sub-partitions could have an additional split in either direction.

### CROSS REFERENCE TO RELATED APPLICATION

This application claims the benefit of European Application Serial No. 22305946.0, filed Jun. 29, 2022, which is incorporated by reference herein in its entirety.

### TECHNICAL FIELD

At least one of the present embodiments generally relates to a method or an apparatus for video encoding or decoding, compression or decompression.

### BACKGROUND

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

At least one of the present embodiments generally relates to a method or an apparatus for video encoding or decoding, and more particularly, to a method or an apparatus for improving the coding efficiency of intra sub-block partitioning using intra coded prediction.

According to a first aspect, there is provided a method. The method comprises steps for splitting a sub-partition of a video block using intra sub partition mode based on a condition; predicting said sub-partition using reconstructed portions of other sub-partitions of the video block; and, encoding the current sub-partition using the prediction.

According to a second aspect, there is provided another method. The method comprises steps for splitting a sub-partition of a video block using intra sub partition mode based on a condition; predicting said sub-partition using reconstructed portions of other sub-partitions of the video block; and, decoding the current sub-partition using the prediction.

According to another aspect, there is provided an apparatus. The apparatus comprises a processor. The processor can be configured to encode a block of a video or decode a bitstream by executing any of the aforementioned methods.

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of a video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

FIG. 1 illustrates the 67 Intra prediction modes, such as in VVC.

FIG. 2 illustrates an example current luminance block and its reference samples.

FIG. 3 illustrates sub-partitions depending on block size.

FIG. 4 illustrates how ISP uses a reference line above but not left sub-partitions when prediction is done with a vertical mode.

FIG. 5 illustrates a proposed change for ISP allowing sub-partitions 2 and 3 to use reconstructed samples from sub-partitions 0 and 1.

FIG. 6 illustrates an example of reference areas to use when performing TIMD on an ISP block.

FIG. 7 illustrates one embodiment of an apparatus for implementing the described aspects.

FIG. 8 illustrates one embodiment of a method for performing the described aspects.

FIG. 9 illustrates another embodiment of a method for performing the described aspects.

FIG. 10 illustrates a generic video encoding or compression system.

FIG. 11 illustrates a generic video decoding or decompression system.

FIG. 12 illustrates a processor-based system for implementing the described aspects.

### DETAILED DESCRIPTION

The general aspects described herein relate to improvements for intra video coding of sub-partitions, which is an intra prediction tool for block-based video coding. The intra prediction is a fundamental coding tool in video compression. The encoder selects the best prediction mode and signals its index to the decoder to perform the same prediction. Signaling the mode can add extra overhead and reduce the gain from intra part. Therefore, a smart way of coding the mode is to select a set of most probable modes and thus reduce the signaling overhead if the mode is within that list. This is a classical method for signaling the intra prediction mode, known as MPM list based signaling, which is employed in VVC (Versatile Video Coding) and HEVC (High Efficiency Video Coding). This method is extended in ECM (Enhanced Compression Model), where 2 MPM (Most Probable Mode) lists are used instead of one, where the first list contains 6 MPMs, and the second list contains another 16 MPMs.

In ECM, two additional intra prediction modes are introduced. The first is known as Decoder-side Intra Mode Derivation (DIMD) and the second is known as Template-based Intra Mode Derivation (TIMD). In both modes, the reconstructed pixels surrounding the current block on the top and left directions (template pixels) are used to derive the intra prediction modes. Specifically, in DIMD, the template of reconstructed pixels is analyzed to deduce the directionality of the template, from which two directional modes are selected. The prediction signal is generated from blending those two modes with planar mode. In TIMD, on the other hand, intra prediction modes are tested on the template of reconstructed pixels and the two best modes are selected (those which minimize the Sum of Absolute Transform Difference (SATD) between the template of reconstructed pixels and its prediction). The prediction signal is generated from blending those two modes.

Another tool present in VVC and ECM to increase the quality of the prediction is Intra Sub Partition (ISP). This tool further splits a CB into up to 4 sub-partitions so that the prediction and transform are applied independently for each sub-partition while all the sub-partition use the same tool and index. This allows the later sub-partition to use the reconstructed samples from the earlier sub-partition without having the extra cost of partitioning plus signaling the mode on each partition.

The next sections give more details on the various intra tools used in the ECM and VVC.

Intra Mode Coding with 67 Intra Prediction Modes [from JVET-X2002]

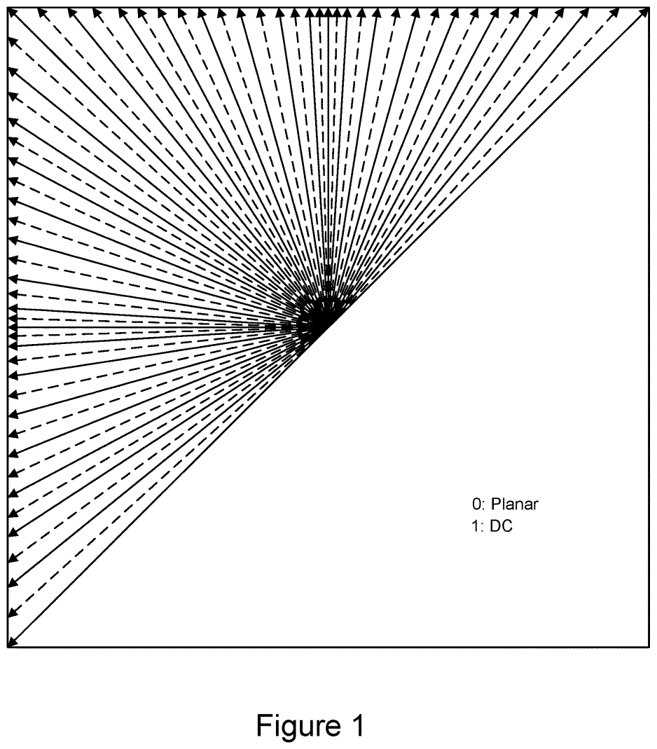

To capture the arbitrary edge directions presented in natural video, the number of directional intra modes in VVC is extended from 33, as used in HEVC, to 65. The new directional modes not in HEVC are depicted as dotted arrows in FIG. 1, and the planar and DC modes remain the same. These denser directional intra prediction modes apply for all block sizes and for both luma and chroma intra predictions.

In VVC, several conventional angular intra prediction modes are adaptively replaced with wide-angle intra prediction modes for the non-square blocks. Wide angle intra prediction is described in a later section.

In HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks because it is always power of 2.

### Intra Mode Coding

To keep the complexity of the most probable mode (MPM) list generation low, an intra mode coding method with 6 MPMs is used by considering two available neighboring intra modes. The following three aspects are considered to construct the MPM list:
Default intra modes
Neighbouring intra modes
Derived intra modes

A unified 6-MPM list is used for intra blocks irrespective of whether MRL and MIP coding tools are applied or not. The MPM list is constructed based on intra modes of the left and above neighboring block. Suppose the mode of the left is denoted as Left and the mode of the above block is denoted as Above, the unified MPM list is constructed as follows:
When a neighboring block is not available, its intra mode is set to Planar by default.
If both modes Left and Above are non-angular modes:
   MPM list a {Planar, DC, V, H, V−4, V+4}
If one of modes Left and Above is angular mode, and the other is non-angular:
   Set a mode Max as the larger mode in Left and Above
   MPM list a {Planar, Max, Max−1, Max+1, Max−2, Max+2}
If Left and Above are both angular and they are different:
   Set a mode Max as the larger mode in Left and Above
   Set a mode Min as the smaller mode in Left and Above
   If Max−Min is equal to 1:
      MPM list á {Planar, Left, Above, Min−1, Max+1, Min−2}
   Otherwise, if Max−Min is greater than or equal to 62:
      MPM list á {Planar, Left, Above, Min+1, Max−1, Min+2}
   Otherwise, if Max−Min is equal to 2:
      MPM list á {Planar, Left, Above, Min+1, Min−1, Max+1}
   Otherwise:
      MPM list a {Planar, Left, Above, Min−1, −Min+1, Max−1}
If Left and Above are both angular and they are the same:
   MPM list á {Planar, Left, Left−1, Left+1, Left−2, Left+2}

Besides, the first bin of the MPM index codeword is CABAC context coded. In total three contexts are used, corresponding to whether the current intra block is MRL enabled, ISP enabled, or a normal intra block.

During 6 MPM list generation process, pruning is used to remove duplicated modes so that only unique modes can be included into the MPM list. For entropy coding of the 61 non-MPM modes, a Truncated Binary Code (TBC) is used.

### Template-Based Intra Mode Derivation (TIMD)

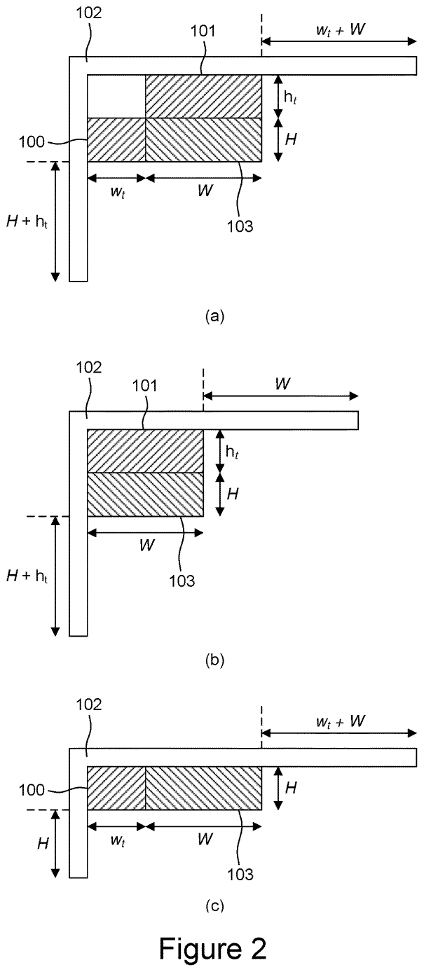

For a given luminance CB, (103) in FIG. 2(a), the following modes derivation via TIMD applies the same way on the encoder and decoder sides. For each intra prediction mode in the MPM list of this luminance CB, if needed, supplemented with default modes, this mode computes a prediction of the template (100 and 101) of this luminance CB from the decoded reference samples of the template (102), and the SATD between this prediction and the template of this luminance CB is calculated. The two intra prediction modes with the minimum SATDs are selected as the TIMD modes. Note that, for TIMD, the set of directional intra prediction modes is extended from 65 to 129, by inserting a direction between each solid arrow and its neighboring dotted arrow in FIG. 1. This means that the set of possible intra prediction modes derived via TIMD gathers 131 modes. After retaining two intra prediction modes from the first pass of tests involving the MPM list supplemented with default modes, for each of these two modes, if this mode is neither PLANAR nor DC, TIMD also tests in terms of prediction SATD its two closest extended directional intra prediction modes. Note that, in the above description, it is assumed that the template of the luminance CB does not go out of the bounds of the current frame. In the case where at least one portion of the template of the luminance CB goes out of the bounds of the current frame, see FIG. 2 (b) and FIG. 2 (c).

FIG. 2 shows a template of the current luminance CB and decoded reference samples of the template. In (a), the current W×H luminance CB (103) is surrounded by its fully available template, made of a wₜ×H portion on its left side (100) and a W×hₜ portion above it (101). During the TIMD derivation step, a tested intra prediction mode predicts the template of the current luminance CB from the set of 1+2 wₜ+2W+2 hₜ+2H decoded reference samples (102) of the template. In the current version of ECM (ECM-4.0), wₜ equals 2 if W≤8, wₜ equals 4 otherwise. hₜ equals 2 if H≤8, hₜ equals 4 otherwise. In (b), the current W×H luminance CB (103) is surrounded by its template with only its W×hₜ portion above it (101) available. During the TIMD derivation step, a tested intra prediction mode predicts the template of the current luminance CB from the set of 1+2 W+2 hₜ+2H decoded reference samples (102) of the template. In (c), the current W×H luminance CB (103) is surrounded by its template with only its wₜ×H portion on its left side (100) available. During the TIMD derivation step, a tested intra prediction mode predicts the template of the current luminance CB from the set of 1+2 wₜ+2 W+2H decoded reference samples (102) of the template.

To predict the current luminance CB via TIMD, the two predictions of the luminance CB via the two TIMD modes resulting from the two passes of tests are fused with weights after applying PDPC. The used weights depend on the prediction SATDs of the two TIMD modes.

It should also be noted that the TIMD search has a built-in stop in the search. If the cost found for the secondary mode falls below a threshold maxCost the search is immediately stopped and the found secondary best mode will be used for the TIMD mode. The maxCost value is computed based on the area of the available template. If the available template is the above neighbor maxCost is set to W×hₜ. If the available template is the left, maxCost is set to H×wₜ. If both the left and above neighbors are available, maxCost is set to H×wₜ+W×hₜ.

As, for TIMD, the set of directional intra prediction modes is extended from 65 to 129, the intra prediction modes substitution in WAIP is adapted. Table 1 becomes Table 2. For instance, for a given 8×4 luminance CB using TIMD, mode 2 is replaced by wide angle mode 131, mode 3 is replaced by wide angle mode 132, mode 4 is replaced by wide angle mode 133, . . . , mode 12 is replaced by wide angle mode 141.

TABLE 1
indices of the intra prediction modes replaced by wide-angular
modes in VVC and ECM (67 core intra prediction modes).

| condition | replaced intra prediction modes indices |
|---|---|
| W/H == 2 | 2, 3, 4, 5, 6, 7 |
| W/H == 4 | 2, 3, 4, 5, 6, 7, 8, 9, 10, 11 |
| W/H == 8 | 2, 3, 4, 5, 6, 7, 8, 9, 10, 11, 12, 13 |
| W/H == 16 | 2, 3, 4, 5, 6, 7, 8, 9, 10, 11, 12, 13, 14, 15 |
| W/H == 32 | 2, 3, 4, 5, 6, 7, 8, 9, 10, 11, 12, 13, 14, 15, 16 |
| W/H == 1 | none |
| H/W == 2 | 61, 62, 63, 64, 65, 66 |
| H/W == 4 | 57, 58, 59, 60, 61, 62, 63, 64, 65, 66 |
| H/W == 8 | 55, 56, 57, 58, 59, 60, 61, 62, 63, 64, 65, 66 |
| H/W == 16 | 53, 54, 55, 56, 57, 58, 59, 60, 61, 62, 63, 64, 65, 66 |
| H/W == 32 | 52, 53, 54, 55, 56, 57, 58, 59, 60, 61, 62, 63, 64, 65, 66 |

TABLE 2
indices of the intra prediction modes replaced
by wide-angular modes in TIMD in ECM.

| condition | replaced intra prediction modes indices |
|---|---|
| W/H == 2 | [\|2, 12\|] |
| W/H == 4 | [\|2, 20\|] |
| W/H == 8 | [\|2, 24\|] |
| W/H == 16 | [\|2, 28\|] |
| W/H == 32 | [\|2, 30\|] |
| W/H == 1 | none |
| H/W == 2 | [\|120, 130\|] |
| H/W == 4 | [\|112, 130\|] |
| H/W == 8 | [\|108, 130\|] |
| H/W == 16 | [\|104, 130\|] |
| H/W == 32 | [\|102, 130\|] |

Intra Sub Partition (ISP) Mode [from JVET-V2002]

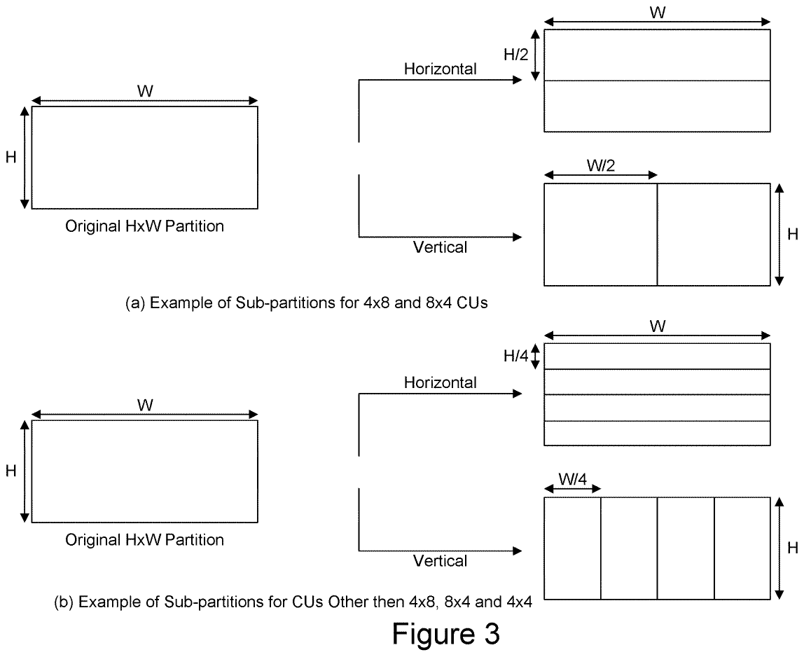

The intra sub-partitions (ISP) divides luma intra-predicted blocks vertically or horizontally into 2 or 4 sub-partitions depending on the block size. For example, minimum block size for ISP is 4×8 (or 8×4). If block size is greater than 4×8 (or 8×4) then the corresponding block is divided by 4 sub-partitions. The CU sizes that can use ISP is restricted to a maximum of 64×64. FIG. 3 shows examples of the two possibilities. All sub-partitions fulfill the condition of having at least 16 samples.

In ISP, the dependence of 1×N/2×N subblock prediction on the reconstructed values of previously decoded 1×N/2×N subblocks of the coding block is not allowed so that the minimum width of prediction for subblocks becomes four samples. For example, an 8×N (N>4) coding block that is coded using ISP with vertical split is split into two prediction regions each of size 4×N and four transforms of size 2×N. Also, a 4×N coding block that is coded using ISP with vertical split is predicted using the full 4×N block; four transform each of 1×N is used. Although the transform sizes of 1×N and 2×N are allowed, it is asserted that the transform of these blocks in 4×N regions can be performed in parallel. For example, when a 4×N prediction region contains four 1×N transforms, there is no transform in the horizontal direction; the transform in the vertical direction can be performed as a single 4×N transform in the vertical direction. Similarly, when a 4×N prediction region contains two 2×N transform blocks, the transform operation of the two 2×N blocks in each direction (horizontal and vertical) can be conducted in parallel. Thus, there is no delay added in processing these smaller blocks than processing 4×4 regular-coded intra blocks.

TABLE 3
Entropy coding coefficient group size

| | Coefficient |
|---|---|
| Block Size | group Size |
| 1 × N, N ≥ 16 | 1 × 16 |
| N × 1, N ≥ 16 | 16 × 1 |
| 2 × N, N ≥ 8 | 2 × 8 |
| N × 2, N ≥ 8 | 8 × 2 |
| All other possible M × N cases | 4 × 4 |

For each sub-partition, reconstructed samples are obtained by adding the residual signal to the prediction signal. Here, a residual signal is generated by the processes such as entropy decoding, inverse quantization and inverse transform. Therefore, the reconstructed sample values of each sub-partition are available to generate the prediction of the next sub-partition, and each sub-partition is processed repeatedly. In addition, the first sub-partition to be processed is the one containing the top-left sample of the CU and then continuing downwards (horizontal split) or rightwards (vertical split). As a result, reference samples used to generate the sub-partitions prediction signals are only located at the left and above sides of the lines. All sub-partitions share the same intra mode. The followings are summary of interaction of ISP with other coding tools.
Multiple Reference Line (MRL): if a block has an MRL index other than 0, then the ISP coding mode will be inferred to be 0 and therefore ISP mode information will not be sent to the decoder.
Entropy coding coefficient group size: the sizes of the entropy coding subblocks have been modified so that they have 16 samples in all possible cases, as shown in Table 3. Note that the new sizes only affect blocks produced by ISP in which one of the dimensions is less than 4 samples. In all other cases coefficient groups keep the 4×4 dimensions.
CBF coding: it is assumed at least one of the sub-partitions has a non-zero CBF. Hence, if n is the number of sub-partitions and the first n−1 sub-partitions have produced a zero CBF, then the CBF of the n-th sub-partition is inferred to be 1.
Transform size restriction: all ISP transforms with a length larger than 16 points uses the DCT-II.
MTS flag: if a CU uses the ISP coding mode, the MTS CU flag will be set to 0 and it will not be sent to the decoder. Therefore, the encoder will not perform RD tests for the different available transforms for each resulting sub-partition. The transform choice for the ISP mode will instead be fixed and selected according the intra mode, the processing order and the block size utilized. Hence, no signalling is required. For example, let t_{H} and t_{V} be the horizontal and the vertical transforms selected respectively for the w×h sub-partition, where w is the width and h is the height. Then the transform is selected according to the following rules:
   If w=1 or h=1, then there is no horizontal or vertical transform respectively.
   If w≥4 and w≤16, t_{H}=DST-VII, otherwise, t_{H}=DCT-II
   If h≥4 and h≤16, t_{V}=DST-VII, otherwise, t_{V}=DCT-II
      In ISP mode, all 67 intra modes are allowed. PDPC is also applied if corresponding width and height is at least 4 samples long. In addition, the reference sample filtering process (reference smoothing) and the condition for intra interpolation filter selection doesn't exist anymore, and Cubic (DCT-IF) filter is always applied for fractional position interpolation in ISP mode.

### Intra Sub-Partition (ISP)

One of the main benefits of the Intra Sub Partition mode is that it allows the use of reconstructed information in ways that were not previously possible with regular partitioning. We propose some changes to the ISP mode to make better use of those information.

### Advance Split for ISP

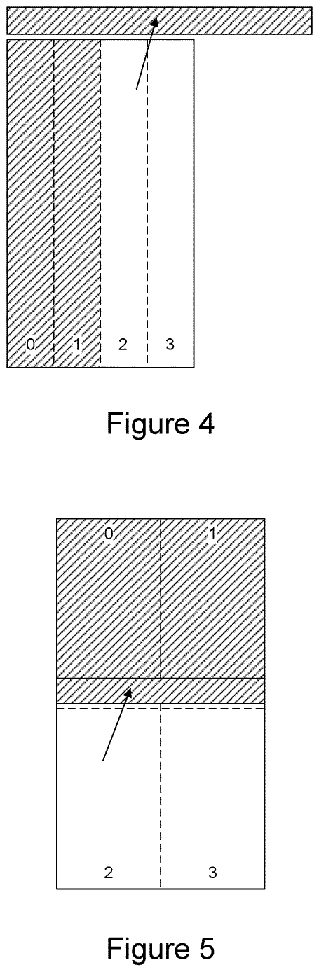

When ISP is used to split vertically a vertical CU with a vertical Intra Prediction Mode (IPM) (resp. horizontally) it does not make use of the available reconstructed samples as shown in FIG. 4. In FIG. 4, ISP uses the reference line of samples above the reconstructed sub-partitions 0 through 3 and does not make use of the reconstructed sub-partitions 0 and 1 when predicting sub-partition 1 with a vertical mode.

It is suggested to change the ISP partitioning in certain instances. Specifically, when the ISP direction and IPM are both vertical (resp. horizontal) it is suggested to change the splitting for the sub-partitions. Depending on the embodiment, the IPMs considered vertical can be all IPMs with index greater than 34 (even though some of those would end up partially using the left reference samples as well), or the IPMs considered vertical could be only IPMs with an index value greater than 50 (to only account for modes that only use the above reference samples). The split could then be the same as a quad-tree, for example, as shown in FIG. 5. This change for ISP would allow for sub-partitions 2 and 3 to use the reconstructed samples from the sub-partitions 0 and 1.

In another example, FIG. 5 could have an additional vertical split to retain 4 thinner partitions in the top side, and 4 thinner partitions in the bottom side.

### Signaling of Advance Split for ISP

In some embodiments the advance split is inferred by the decoder. For example, when a luma CB using ISP with a vertical intra mode (resp. horizontal), if the ISP mode signaled is a vertical split (resp. horizontal) the advance split will be used instead.

In some other embodiments the advanced split can be signaled explicitly by adding a bit in order to keep all existing split possibilities. The specification text could be changed to the following (from JVET-T2001), additions are underlines, deletions are [[double-bracketed]]:

The variable IntraSubPartitionsSplitType specifies the type of split used for the current luma coding block as illustrated in Table 13. IntraSubPartitionsSplitType is derived as follows:
If intra_subpartitions_mode_flag is equal to 0, IntraSubPartitionsSplitType is set equal to 0.
If adv isp split mode flag is equal to 1, the IntraSubPartitionsSplitType is set equal to ISP ADV SPLIT.
Otherwise, the IntraSubPartitionsSplitType is set equal to 1+intra_subpartitions_split_flag.

TABLE 13
Name association to IntraSubPartitionsSplitType

| IntraSubPartitionsSplitType | Name of IntraSubPartitionsSplitType |
|---|---|
| 0 | ISP_NO_SPLIT |
| 1 | ISP_HOR_SPLIT |
| 2 | ISP_VER_SPLIT |
| 3 | ISP ADV SPLIT |

### Variant on Direction Dependent ISP

In another variant it could be disallowed to use both ISP vertical split and a vertical mode on a vertical CB (resp. horizontal). This saves signaling cost for ISP in CBs that are not likely to use those splits. In this case, there is no need to signal the ISP direction when a vertical luma CB is using a vertical mode (resp. horizontal).

### ISP and TIMD/DIMD

The examples in this section mention TIMD as it is allowed in combination with ISP in ECM-4.0 but would also be applicable to DIMD if the combination of DIMD and ISP was allowed in a future version of ECM.

When ISP and TIMD are both used on a CB, the TIMD process is performed once for the CB. We suggest redoing the TIMD process for each sub-partition to allow for different modes to be used at no signaling cost. In this example the TIMD process would be performed independently for each PB in the ISP CB. In some examples this would be restricted to certain block sizes.

In some embodiments, to reduce the increase in runtime due to the TIMD search on each ISP sub-partition, it is suggested to not do the same search as in TIMD, but rather only test a sub-set of the modes that would be regularly tested.
In some embodiments only the neighboring modes of the mode used in the first partition are allowed. Only the Nth angular neighbors of the mode used in the first partition would be allowed (e.g. if the selected mode is 62 in the first partition and N is selected to 2, the TIMD search would only test the angular modes 60, 61, 62, 63, 64).
In some embodiments, the previous point would also extend to wide angles, and include modes that are directly opposite (180°) to the tested modes. This could include modes that are not usually available for coding the current block size
In some embodiments, the first TIMD mode is not changed for the partition, and only the secondary mode, used for merging, is replaced in the ISP sub-partitions.

In some embodiments this is combined with the previous complexity reduction methods.
In some embodiments, the merging part of TIMD is removed, so that only one mode is used for each sub-partition.

In some embodiments, the value of maxCost, described in the section on TIMD, set to stop the search if a sufficiently good enough mode is found, is set to 0. This allows the additional search to fully evaluate all available modes and potentially find a better mode than originally.

In some embodiments, a weight can be added to TIMD template search when performed with ISP. For example, in FIG. 4, when predicting the partition 2, the reconstructed part coming from partition 1 can provide more accurate information than the information from the original reference samples (green area). Therefore, some embodiments may choose to compute the cost of the template prediction for TIMD with a more important weight on the partition from the same PB than from outside the PB.

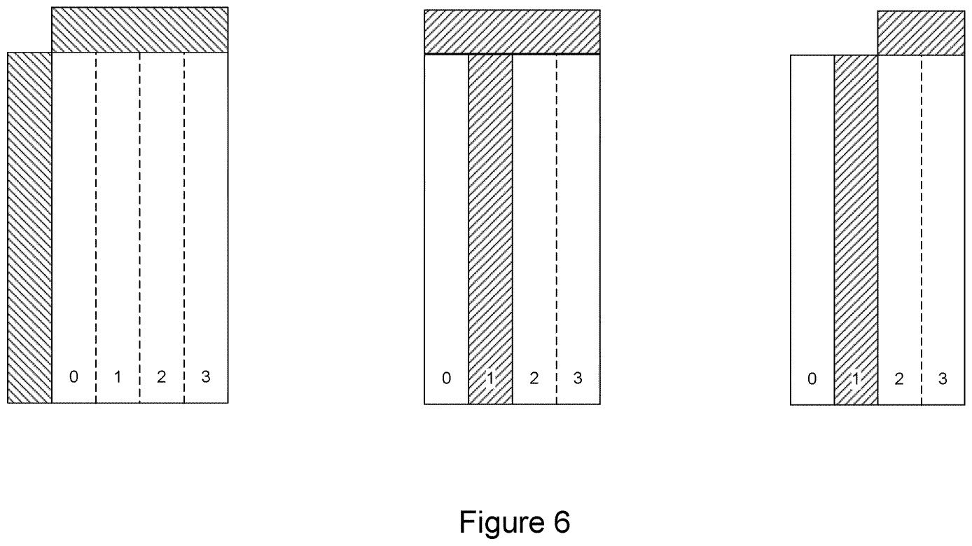

In some embodiments, template in TIMD could be adapted when performed with ISP. For one sub-partition in the ISP CB, if some preceding sub-partitions are available, the template used for TIMD search could be the reconstructed samples from these preceding sub-partitions, rather than using neighboring CB. For example, in FIG. 6, when predicting intra prediction mode for the partition 2, the reconstructed part coming from partitions 0 and 1 can provide more accurate information than the information from the original neighboring template samples (light gray area in FIG. 6). Therefore, the left directional template samples used for TIMD of partition 2 could be composed by the reconstructed samples from partitions 0 and 1 (dark gray area in FIG. 6).

In another variant, only the samples from the closest adjacent reconstructed sub-partition of current sub-partition are considered. For example, only the reconstructed samples from partition 1 could be used as the TIMD template for partition 2.

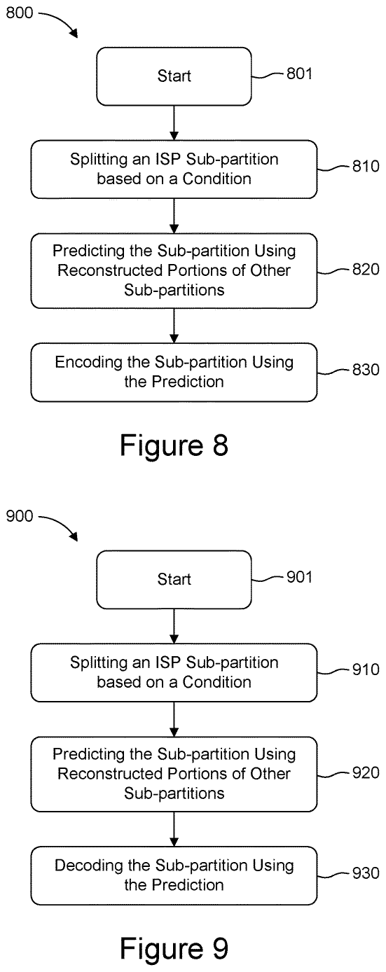

One embodiment of a method 800 under the general aspects described here is shown in FIG. 8. The method commences at start block 801 and control proceeds to block 810 for splitting a sub-partition of a video block using intra sub partition mode based on a condition. Control proceeds from block 810 to block 820 for predicting said sub-partition using reconstructed portions of other sub-partitions of the video block. Control proceeds from block 820 to block 830 for encoding the current sub-partition using the prediction.

One embodiment of a method 900 under the general aspects described here is shown in FIG. 9. The method commences at start block 901 and control proceeds to block 910 for splitting a sub-partition of a video block using intra sub partition mode based on a condition. Control proceeds from block 910 to block 920 for predicting said sub-partition using reconstructed portions of other sub-partitions of the video block. Control proceeds from block 920 to block 930 for decoding the current sub-partition using the prediction.

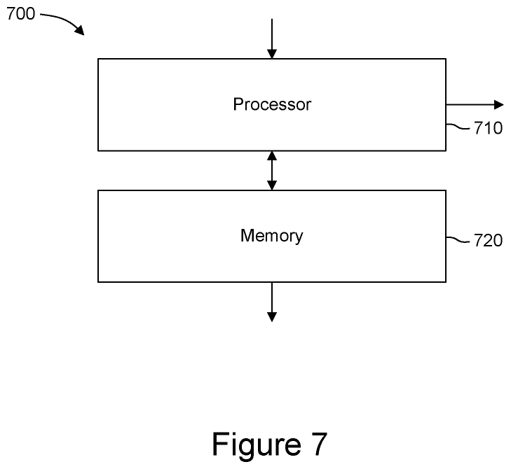

FIG. 7 shows one embodiment of an apparatus 700 for implementing any of the aforementioned methods of intra mode derivation. The apparatus comprises Processor 710 and can be interconnected to a memory 720 through at least one port. Both Processor 710 and memory 720 can also have one or more additional interconnections to external connections.

Processor 710 is also configured to either insert or receive information in a bitstream and, either compressing, encoding, or decoding using any of the described aspects.

The embodiments described here include a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

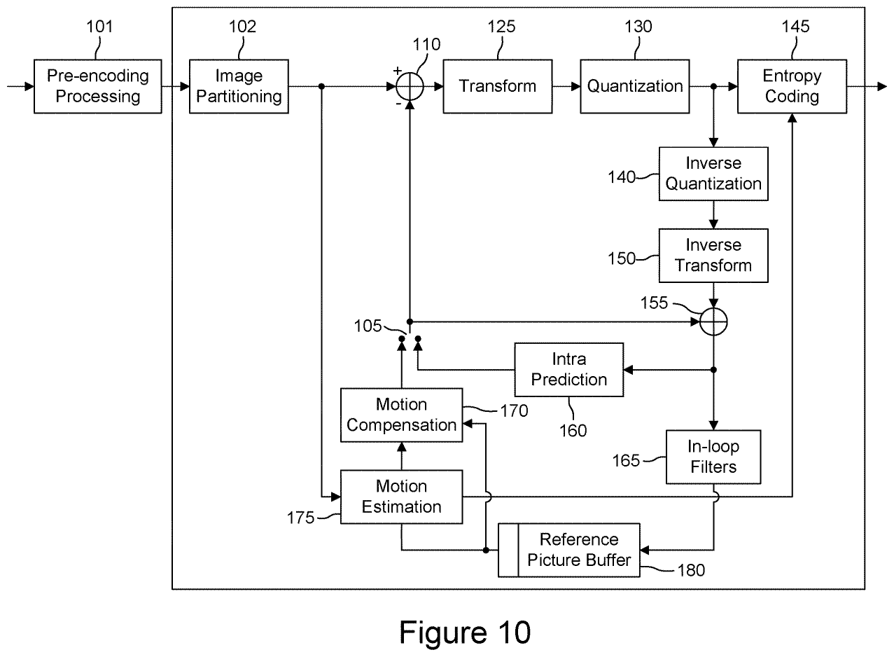

The aspects described and contemplated in this application can be implemented in many different forms. FIGS. 10, 11, and 12 provide some embodiments, but other embodiments are contemplated and the discussion of FIGS. 10, 11, and 12 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined.

Various methods and other aspects described in this application can be used to modify modules, for example, the intra prediction, entropy coding, and/or decoding modules (160, 360, 145, 330), of a video encoder 100 and decoder 200 as shown in FIG. 22 and FIG. 23. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application. The specific values are for example purposes and the aspects described are not limited to these specific values.

FIG. 10 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset) filtering to reduce encoding artifacts. The filtered image is stored at a reference picture buffer (180).

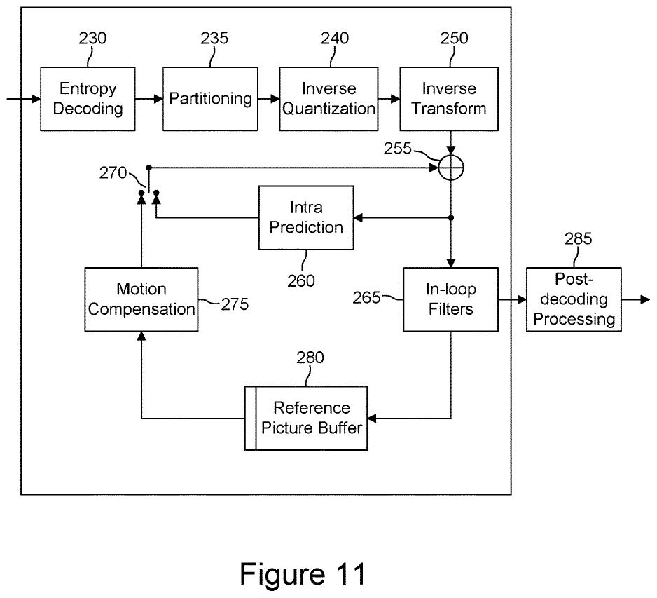

FIG. 11 illustrates a block diagram of a video decoder 200. In the decoder 200, a bitstream is decoded by the decoder elements as described below. Video decoder 200 generally performs a decoding pass reciprocal to the encoding pass as described in FIG. 10. The encoder 100 also generally performs video decoding as part of encoding video data.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g., conversion from YcbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

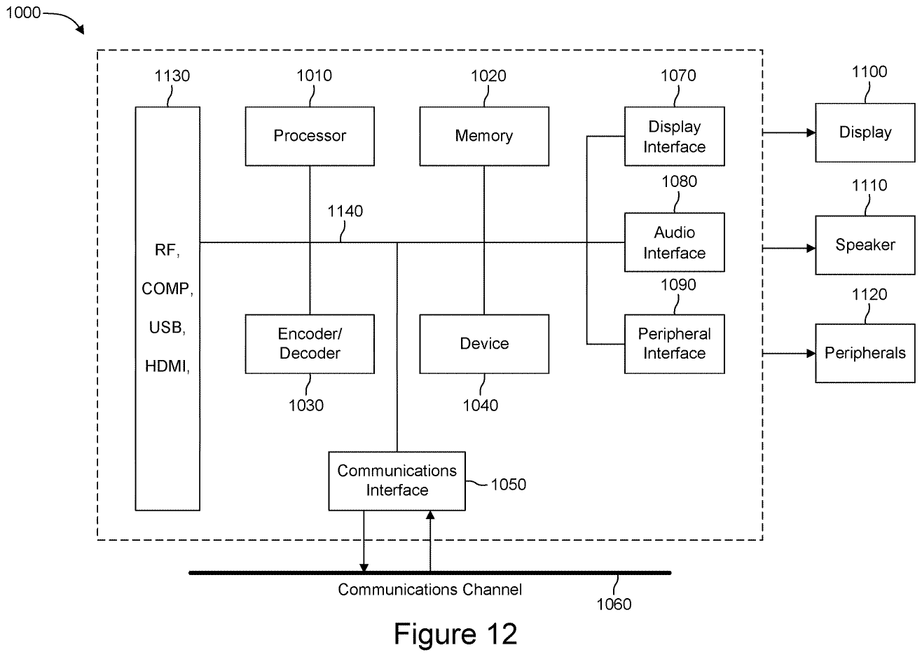

FIG. 12 illustrates a block diagram of an example of a system in which various aspects and embodiments are implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 12, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface Ics or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement, for example, an internal bus as known in the art, including the Inter-IC (12C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or another device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments may refer to parametric models or rate distortion optimization. In particular, during the encoding process, the balance or trade-off between the rate and distortion is usually considered, often given the constraints of computational complexity. It can be measured through a Rate Distortion Optimization (RDO) metric, or through Least Mean Square (LMS), Mean of Absolute Errors (MAE), or other such measurements. Rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of transforms, coding modes or flags. In this way, in an embodiment the same transform, parameter, or mode is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream.

The information that the signal carries can be, for example, analog or digital information. The signal can be transmitted over a variety of different wired or wireless links, as is known. The signal can be stored on a processor-readable medium.

The preceding sections describe a number of embodiments, across various claim categories and types. Features of these embodiments can be provided alone or in any combination. Further, embodiments can include one or more of the following features, devices, or aspects, alone or in any combination, across various claim categories and types:

One embodiment comprises splitting a sub-partition of a video block using intra sub partition mode based on a condition, predicting the sub-partition using reconstructed portions of other sub-partitions of the video block; and encoding/decoding the current sub-partition using the prediction.

One embodiment comprises the above method wherein the condition is whether an intra prediction mode is in a same direction as the sub-partition.

One embodiment comprises the above method wherein the condition is signaled.

One embodiment comprises the above method, further comprising splitting said split sub-partitions in another direction.

One embodiment comprises the above method wherein said splitting is inferred from information of a luminance component of said current video block.

One embodiment comprises the above method, further comprising performing a template based intra mode derivation for a sub-partition of the video block.

One embodiment comprises the above method, wherein said template based intra mode derivation is performed for a subset of block sizes.

One embodiment comprises a bitstream or signal that includes one or more syntax elements to perform the above functions, or variations thereof.

One embodiment comprises a bitstream or signal that includes syntax conveying information generated according to any of the embodiments described.

One embodiment comprises creating and/or transmitting and/or receiving and/or decoding according to any of the embodiments described.

One embodiment comprises a method, process, apparatus, medium storing instructions, medium storing data, or signal according to any of the embodiments described.

One embodiment comprises inserting in the signaling syntax elements that enable the decoder to determine decoding information in a manner corresponding to that used by an encoder.

One embodiment comprises creating and/or transmitting and/or receiving and/or decoding a bitstream or signal that includes one or more of the described syntax elements, or variations thereof.

One embodiment comprises a TV, set-top box, cell phone, tablet, or other electronic device that performs transform method(s) according to any of the embodiments described.

One embodiment comprises a TV, set-top box, cell phone, tablet, or other electronic device that performs transform method(s) determination according to any of the embodiments described, and that displays (e.g. using a monitor, screen, or other type of display) a resulting image.

One embodiment comprises a TV, set-top box, cell phone, tablet, or other electronic device that selects, bandlimits, or tunes (e.g. using a tuner) a channel to receive a signal including an encoded image, and performs transform method(s) according to any of the embodiments described.

One embodiment comprises a TV, set-top box, cell phone, tablet, or other electronic device that receives (e.g. using an antenna) a signal over the air that includes an encoded image, and performs transform method(s).

1. A method, comprising:
splitting a sub-partition of a video block using intra sub partition mode based on a condition;
predicting said sub-partition using reconstructed portions of other sub-partitions of the video block; and,
encoding the current sub-partition using the prediction.

2. An apparatus, comprising:
a processor, configured to perform:
splitting a sub-partition of a video block using intra sub partition mode based on a condition;
predicting said sub-partition using reconstructed portions of other sub-partitions of the video block; and,
encoding the current sub-partition using the prediction.

3. A method, comprising:
splitting a sub-partition of a video block using intra sub partition mode based on a condition;
predicting said sub-partition using reconstructed portions of other sub-partitions of the video block; and,
decoding the current sub-partition using the prediction.

4. An apparatus, comprising:
a processor, configured to perform:
splitting a sub-partition of a video block using intra sub partition mode based on a condition;
predicting said sub-partition using reconstructed portions of other sub-partitions of the video block; and,
decoding the current sub-partition using the prediction.

5. The method of claim 1, wherein the condition is whether an intra prediction mode is in a same direction as the sub-partition.

6. The method of claim 1, wherein the condition is signaled.

7. The method of claim 1, further comprising splitting said split sub-partitions in another direction.

8. The method of claim 7 wherein said splitting is inferred from information of a luminance component of said current video block.

9. The apparatus of claim 4, further comprising performing a template based intra mode derivation for a sub-partition of the video block.

10. The apparatus of claim 9, wherein said template based intra mode derivation is performed for a subset of block sizes.

11. The apparatus of claim 9, wherein said template based intra mode derivation is restricted to a subset of intra modes.

12. A device comprising:
an apparatus according to claim 4; and
at least one of (i) an antenna configured to receive a signal, the signal including the coding unit, (ii) a band limiter configured to limit the received signal to a band of frequencies that includes the coding unit, and (iii) a display configured to display an output representative of a coding unit.

13. A non-transitory computer readable medium containing data content generated according to the method of claim 1, for playback using a processor.

14. (canceled)

15. A computer program product comprising instructions which, when the program is executed by a computer, cause the computer to carry out the method of claim 3.

16. The method of claim 3, wherein the condition is whether an intra prediction mode is in a same direction as the sub-partition.

17. The method of claim 3, wherein the condition is signaled.

18. The method of claim 3, further comprising splitting said split sub-partitions in another direction.

19. The method or apparatus of claim 18 wherein said splitting is inferred from information of a luminance component of said current video block.

20. The apparatus of claim 4, further comprising performing a template based intra mode derivation for a sub-partition of the video block.

21. The apparatus of claim 20, wherein said template based intra mode derivation is performed for a subset of block sizes.
